(19) United States
(12) Patent Application Publication
(10) Pub. No.: US 2021/0286508 A1
(43) Pub. Date: Sep. 16, 2021

(54) Tablet with an auxiliary display

(71) Applicant: Shenzhen Tianyin Hongye Technology Co., Ltd., Shenzhen (CN)

(72) Inventor: Neng Gang PAN, Shenzhen (CN)

(21) Appl. No.: 16/817,606

(22) Filed: Mar. 13, 2020

(51) Int. Cl. G06F 3/0488; G06F 3/0354; G09B 5/00

(52) U.S. Cl. CPC G06F 3/04883; G09B 5/00; G06F 3/03545

(57) ABSTRACT

A handwriting tablet with an auxiliary display screen includes a handwriting tablet body (1) and a stylus pen (2), which is characterized in that an auxiliary display screen (3) and a control are arranged on the side of the handwriting tablet body (1). The device (4), the auxiliary display screen (3) and the control device (4) are electrically connected. The advantage is that the auxiliary display screen (3) solves the disadvantages of children's graffiti in the absence of guidelines. When handwriting, certain guidelines are given to cultivate children's confidence in talents and talents while learning. Some simple knowledge.

### TECHNICAL FIELD

The invention relates to a digitizer characterized by a conversion mode, and more particularly to a handwriting tablet with an auxiliary display screen.

### BACKGROUND TECHNIQUE

When the tablet is drawing or writing, the stylus pen 2 is given gravity by moving on the liquid crystal display film, so that the polymer particles on the liquid crystal display film are deformed and the orientation is changed, and the light cannot penetrate the liquid crystal display film and refract. The deformed polymer material manufacturer generates a display color that is different from the background color of the liquid crystal display film, so as to achieve the purpose of painting and writing. After painting and writing, a certain voltage and current are given to the polymer material on the liquid crystal display film. Reset, play the role of annihilation. The handwriting pad of the prior art only has a function of displaying handwritten content and does not have a guidance and education function. Most children are scribbling without the guidance of an adult, and after a few times they are not interested. Mining a child's talent has no positive effect. This is its disadvantage.

### SUMMARY OF THE INVENTION

In view of the disadvantages of the prior art, an object of the present invention is to provide a tablet with an auxiliary display screen. Solve the disadvantages of children scribbling without a guideline. When handwriting, give some guidance, develop children's confidence in talents, and at the same time learn some simple knowledge.

The technical solution adopted by the present invention to solve its technical problems is to provide a handwriting tablet with an auxiliary display screen, which includes a handwriting tablet body and a stylus pen, and is characterized in that an auxiliary display screen is arranged on the side of the handwriting tablet body And the control device, the auxiliary display screen is electrically connected with the control device.

further:

The side of the tablet body is an upper side.

It includes a rap, which is electrically connected to the control device.

A camera is included, and the camera is electrically connected to the control device.

The beneficial effect of the present invention is that it solves the disadvantages of children scribbling without a guideline. When handwriting is given, certain guidelines are given to cultivate children's confidence in talents and talents. At the same time, they can learn some simple things. know how.

### BRIEF DESCRIPTION OF THE DRAWINGS

The invention is further described below with reference to the drawings.

FIG. 1 is a schematic front view of the present invention.

FIG. 2 is a schematic rear view of the present invention

FIG. 3 is a schematic diagram of the electrical connection of the present invention.

FIG. 4 is a schematic diagram of a conventional tablet.

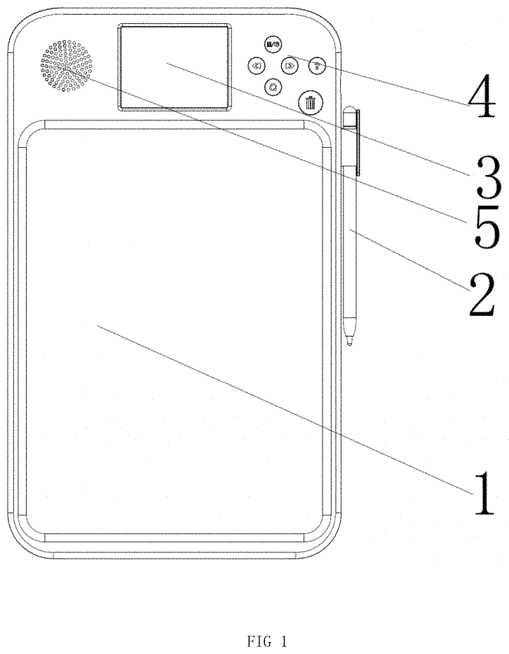

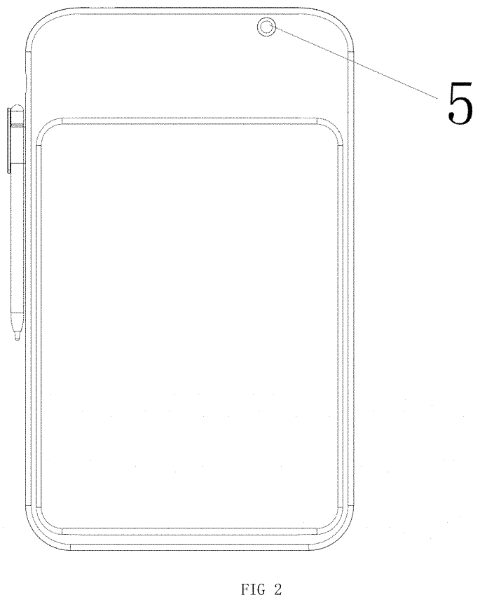

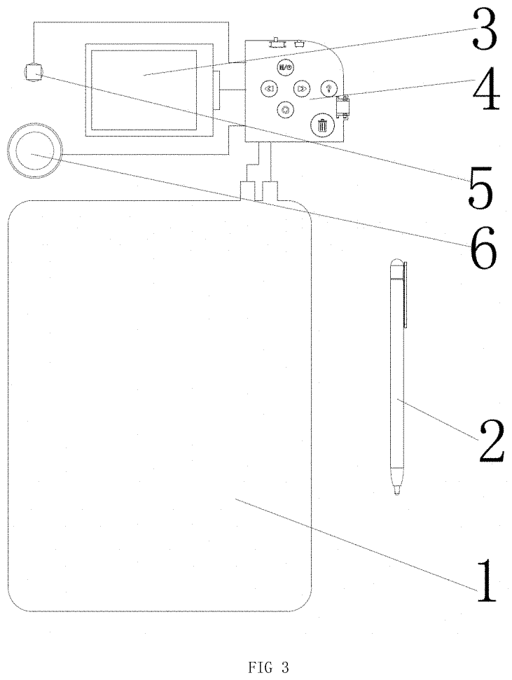

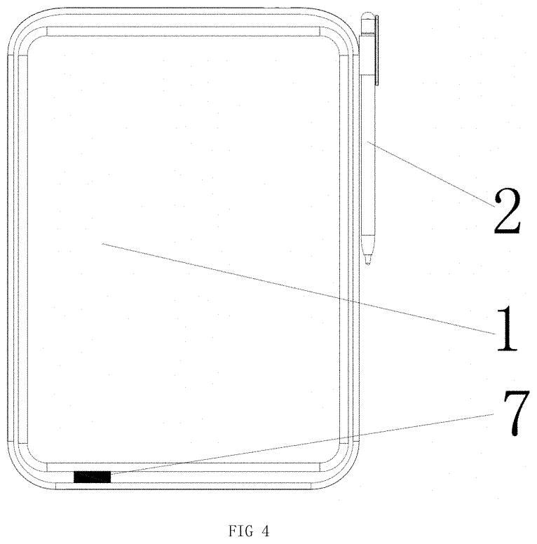

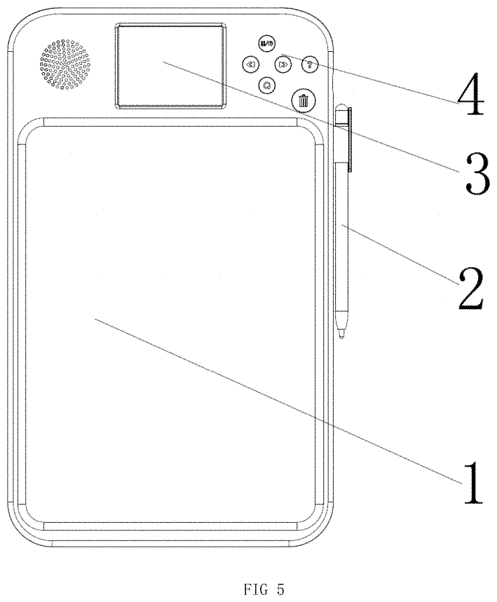

In the picture: 1 is the tablet body, 2 is the stylus pen, 3 is the auxiliary display screen, 4 is the control device, 5 is the camera, 6 is the speaker, and 7 is the clear key.

### DETAILED DESCRIPTION

Referring to the drawings, a tablet with an auxiliary display screen according to the present invention includes a tablet main body 1 and a stylus pen 2, which are characterized in that an auxiliary display screen 3 and a control device 4 are arranged on the side of the tablet main body 1. The auxiliary display screen 3 is electrically connected with the control device 4.

In an embodiment of the invention:

The sides of the tablet body 1 are upper sides.

### DESCRIPTION

It includes a speaker 6 which is electrically connected to the control device 4.

The camera 5 is included, and the camera 5 is electrically connected to the control device 4.

The control device 4 is the core of the product, and transmits data to the auxiliary display 3 for text or picture display; sends the sound signal to the speaker 6 to output sound; the camera 5 is used to collect physical scene data, and transmits the collected data to The control device 4 performs calculations and outputs signals.

The entire tablet body can be divided into two parts, one is the intelligent AI education area, and the other is the painting and writing practice area. They can work independently or together. The control device 4 has a built-in memory, which can put some learning content in the memory through data transmission methods such as copying and burning. Through the chip processing on the control device 4, the image is transmitted to the auxiliary display 3 for display, and the sound data is transmitted. Make a sound to the horn 6 and when the child is enlightened, there can be reference to picture information and video, and there is sound to read and explain. The camera 5 is used as the scene scene data collection point. After the collected data is transmitted to the processor on the control device 4, the data is scanned and edited to generate related picture information and transmitted to the auxiliary display 3 for display. Make effective copies or references when painting.

The control device 4 includes buttons, a PCB/A board, and a control chip. The functions of the control device 4 can be designed by those skilled in the art, and will not be described again.

When drawing and writing in early childhood, provide picture information, video, sound, etc. to guide, so as not to scribble blindly. After booting into the system, select one of the learning content, and assist the display screen 3 to display relevant picture information and content, accompanied by voice guidance and reading. The user performs drawing and writing copy practice on the tablet based on the picture and sound. Tap children's talents and cultivate children's talents interest and confidence.

What is claimed is:

1. A handwriting tablet with an auxiliary display screen, comprising a handwriting tablet body (1) and a stylus pen (2), characterized in that an auxiliary display screen (3) is arranged on the side of the handwriting tablet body (1) And the control device (4), the auxiliary display screen (3) and the control device (4) are electrically connected.

2. The tablet with an auxiliary display screen according to claim 1, characterized in that the side of the tablet body (1) is an upper side.

3. The tablet with an auxiliary display screen according to claim 1, characterized in that it comprises a lab (6), and the lab (6) is electrically connected to the control device (4).

4. The tablet with an auxiliary display screen according to claim 1, further comprising a camera (5), wherein the camera (5) is electrically connected to the control device (4).
